(19) United States
(12) Patent Application Publication
(10) Pub. No.: US 2007/0126402 A1
(43) Pub. Date: Jun. 7, 2007

(54) Battery detection system and related method

(75) Inventors: Shen-Fu Tsai, Taipei (TW); Chien-Kuo Hsu, Taipei (TW)

Correspondence Address: BACON & THOMAS, PLLC, 625 SLATERS LANE, FOURTH FLOOR, ALEXANDRIA, VA, 22314, US

(73) Assignee: PREMIER IMAGE TECHNOLOGY CORPORATION, Taipei (TW)

(21) Appl. No.: 11/502,514

(22) Filed: Aug. 11, 2006

(30) Foreign Application Priority Data
Dec. 2, 2005 (TW) 094142611

(51) Int. Cl. H02J 7/00

(52) U.S. Cl. 320/134

(57) ABSTRACT

A battery detection system and related method are provided. The battery detection system according to the invention is coupled to a battery for detecting the type and remaining power of the battery, and includes a processor coupled to an A/D converter and an I/O control; a circuit, comprising a switch and a load, wherein the I/O control is used to control the switch for enabling or disabling the load. When the load is enabled, the A/D converter obtains a first voltage; when the load is disabled, the A/D converter obtains a second voltage. By calculating the first and second voltages, the processor obtains the type and remaining power of the battery.

### BACKGROUND OF THE INVENTION

1. Field of the Invention

The present invention relates to a battery detection system and a related method, and, more particularly, to a battery detection system and a related method for detecting the type and remaining power of the battery.

2. Description of the Related Art

Generally, electronic device manufacturers need to provide devices that can detect the remaining electrical power in a battery being used to power the device. For example, a digital camera that indicates the amount of battery power remaining can provide to the user the number of available photos; or a digital audio recorder can provide to the user the recording time available.

The prior art technology usually measures the voltage of the battery and utilizes this voltage to estimate the remaining power of the battery according to a predetermined voltage/current relationship table. However, there are various batteries for which, without identifying the type of the battery, the measured voltage does not indicate the actual power.

Therefore, it is desirable to provide a battery detection system and related method for detecting the type and remaining power of a battery to mitigate and/or obviate the aforementioned problems.

### SUMMARY OF THE INVENTION

The present invention provides a battery detection system which is placed in an electronic device and electrically coupled to a battery. The battery detection system is used to determine the type and remaining power of the battery.

The battery detection system comprises: a processor coupled to an A/D converter and an I/O control end; and a circuit comprising a switch and a load, wherein the I/O control end is used for controlling the switch to enable or disable the load.

When a current passes through the load and the load is enabled, the A/D converter obtains a first voltage value of the battery; when a current passes the load and the load is disabled, the A/D converter obtains a second voltage value of the battery; and the processor calculates the first and second voltages to obtain the type and remaining electrical power of the battery. Furthermore, the present invention also provides a battery detection method for obtaining the type and remaining electrical power of a battery in an electronic device. The method comprises following steps:

1. electrically coupling the battery to a circuit, the circuit comprising a switch and a load;

2. controlling the switch to enable the load;

3. when the load is enabled, a current passing through the load to obtain a first voltage value of the battery;

4. controlling the switch to disable the load;

5. when the load is disabled, a current passing through the load to obtain a second voltage value of the battery; and

6. comparing the first voltage value and the second voltage value to obtain the type and remaining electrical power of the battery.

In an embodiment of the present invention, the switch is a metal oxide semiconductor field effect transistor (MOSFET); the load is a resistor; and the battery type includes but not limits to Ni-MH battery, Li battery or alkaline battery.

Moreover, in the embodiment of the present invention, the method compares a voltage drop between the first voltage value and the second voltage value to a predetermined voltage drop characteristic table to obtain the type and remaining electrical power of the battery.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a battery detection system according to the present invention.

FIG. 2 is a flowchart of a battery detection method according to the present invention.

### DETAILED DESCRIPTION OF THE PREFERRED EMBODIMENT

As indicated in the above discussion, when a battery has no load, it is impossible to determine the type and remaining electrical power of the battery by directly detecting the voltage of the battery.

Therefore, since various batteries have different voltage drops when driving current through the same resistance, the present invention adds a resistor and a logic gate (such as a MOSFET) in a battery detection system, and causes the battery detection system to control a current that passes through this resistor, and records the voltage value across the battery before and after enabling of the logic gate. By detecting the voltage drop of the battery, the battery can be identified as a Ni-MH battery, a Li battery or an alkaline battery. Furthermore, different batteries from different manufacturers also have different voltage drop characteristics, and thus the present invention can be used to identify the types of batteries of the different manufacturers.

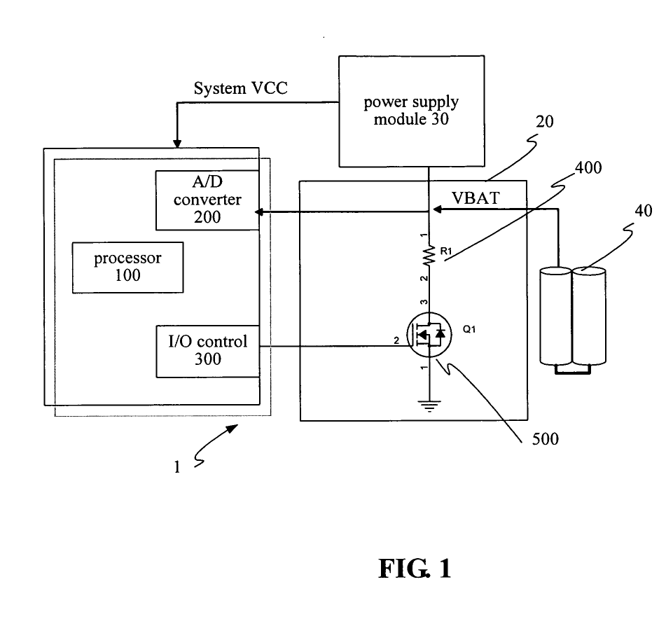

Please refer to FIG. 1. FIG. 1 is a schematic drawing of a battery detection system according to the present invention. As shown in FIG. 1, in an embodiment of the present invention, the battery detection system 1 is disposed in an electronic device (not shown) and electrically coupled to a battery 40 that provides power via a power supply module 30.

The battery detection system 1 comprises a processor 100, an A/D converter 200, I/O control 300 and a circuit 20 having a load 400 and a switch 500. The I/O control end 300 is used for controlling the switch to enable or disable the load 400. In this embodiment, the I/O control end 300 is an I/O control pin, the switch 500 is a metal oxide semiconductor field effect transistor (MOSFET), and the load 400 is a resistor.

The battery detection system 1 utilizes the I/O control end 300 to control the switch 500 to enable the load 400; when a current passes through the load 400, the A/D converter 200 obtains a first voltage value of the battery 40. Similarly, the battery detection system 1 utilizes the I/O control end 300 to control the switch 500 to disable the load 400; when current passes the load 400 and the load 400 is disabled, the A/D converter 200 obtains a second voltage value of the battery 40.

The processor 100 calculates the first voltage value and the second voltage value and then compares them to a predetermined voltage drop characteristic table to identify whether the battery 40 is a Ni-MH battery, a Li battery or an alkaline battery and obtains the remaining electrical power in the battery 40.

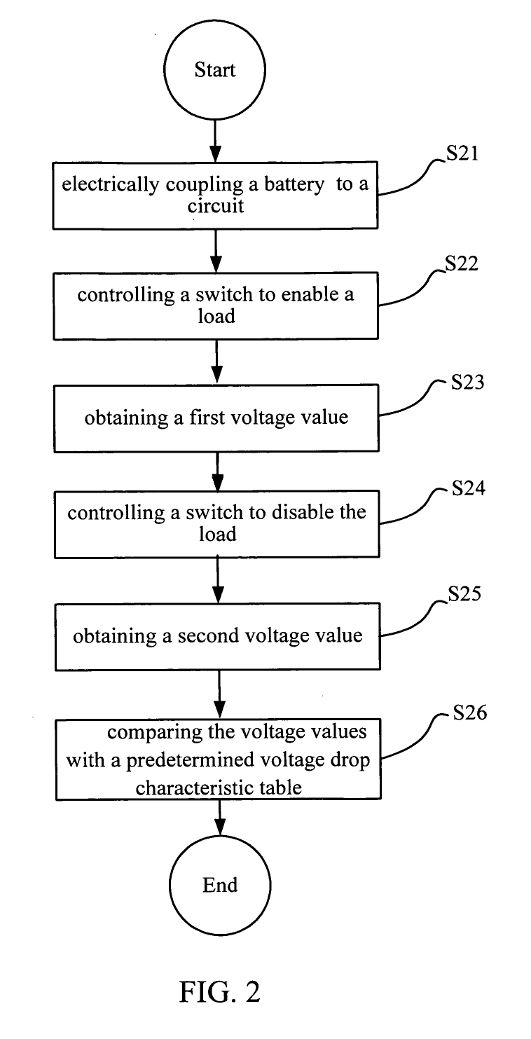

The present invention also provides a battery detection method for detecting the type and remaining power of the battery. Please refer to FIG. 2. FIG. 2 is a flowchart of a battery detection method according to the present invention. As shown in FIG. 2, the method of the present invention comprises steps S21, S22, S23, S24, S25 and S26.

First, in step S21, as shown in FIG. 1, the battery 40 is electrically coupled to the circuit 20, and the circuit 20 has the load 400 (such as resistor) and a switch 500 (such as a MOSFET).

In step S22, the switch 500 is controlled to enable the load 400; and in step S23, when the load 400 is enabled, a current can pass through the load 400 to obtain the first voltage value of the battery 40.

Next, in step S24, the switch 500 is controlled to disable the load 400; and in step S25, when the load 400 is disabled, a current pass through the load 400 to obtain the second voltage value of the battery 40.

When the first voltage value and the second voltage value of the battery 40 are obtained, in step S26, a voltage drop between first voltage value and the second voltage value is compared with the predetermined voltage drop characteristic table to obtain the type and remaining electrical power of the battery.

Although the present invention has been explained in relation to its preferred embodiment, it is to be understood that many other possible modifications and variations can be made without departing from the spirit and scope of the invention as hereinafter claimed.

What is claimed is:

1. A battery detection system, the battery detection system is set in an electronic device and coupled to a battery for detecting the type and remaining electrical power of the battery, the battery detection system comprising:
a processor coupled to an A/D converter and an I/O control end; and
a circuit comprising a switch and a load, wherein the I/O control end is used for controlling the switch to enable or disable the load;
wherein when a current passes through the load and the load is enabled, the A/D converter obtains a first voltage value of the battery; when a current passes the load and the load is disabled, the A/D converter obtains a second voltage value of the battery; and the processor calculates the first and second voltages to obtain at least one of the type and remaining electrical power of the battery.

2. The battery detection system as claimed in claim 1, wherein the I/O control end is an I/O control pin.

3. The battery detection system as claimed in claim 1, wherein the switch is a metal oxide semiconductor field effect transistor (MOSFET).

4. The battery detection system as claimed in claim 1, wherein the load is a resistor.

5. The battery detection system as claimed in claim 1, wherein the type of the battery includes a Ni-MH battery, a Li battery or an alkaline battery.

6. The battery detection system as claimed in claim 1, wherein the processor utilizes a predetermined voltage drop characteristic table to obtain at least one of the type and remaining electrical power of the battery.

7. A battery detection method for obtaining a type and remaining electrical power of a battery in an electronic device, the method comprising:
electrically coupling the battery to a circuit, the circuit comprising a switch and a load;
controlling the switch to enable the load;
when the load is enabled, a current passing through the load to obtain a first voltage value of the battery;
controlling the switch to disable the load;
when the load is disabled, a current passing through the load to obtain a second voltage value of the battery; and
comparing the first voltage value and the second voltage value to obtain at least one of the type and remaining electrical power of the battery.

8. The battery detection method as claimed in claim 7, wherein the switch is a metal oxide semiconductor field effect transistor (MOSFET).

9. The battery detection method as claimed in claim 7, wherein the load is a resistor.

10. The battery detection method as claimed in claim 7, wherein the type of the battery includes a Ni-MH battery, a Li battery or an alkaline battery.

11. The battery detection method as claimed in claim 7 further comprising:
comparing a voltage drop between the first voltage value and the second voltage value to a predetermined voltage drop characteristic table to obtain at least one of the type and remaining electrical power of the battery.
